(19) United States
(12) Patent Application Publication
(10) Pub. No.: US 2010/0148652 A1
(43) Pub. Date: Jun. 17, 2010

(54) Solid state lighting

(76) Inventor: Jan Vetrovec, Larkspur, CO (US)

Correspondence Address: Aqwest LLC, P.O. BOX 468, Larkspur, CO, 80118, US

(21) Appl. No.: 12/592,539

(22) Filed: Nov. 25, 2009

Related U.S. Application Data
(63) Continuation-in-part of application No. 12/290,195, filed on Oct. 28, 2008.
(60) Provisional application No. 61/200,407, filed on Nov. 25, 2008.

(51) Int. Cl. H01J 61/52

(52) U.S. Cl. 313/46

(57) ABSTRACT

The present invention provides a solid-state lighting fixture and lamp for down light for use in applications especially in recessed lighting. In particular, the lamp of the subject invention may be configured as a direct screw-in replacement for common R-30 style incandescent flood lamp and it may be used existing luminaires. In one preferred embodiment of the present invention, a lamp mounted in a recessed light luminaire for down lighting has one or more light emitting diodes (LEDs) that are thermally coupled to a heat sink having fins for cooling by ambient air. The fins are configured so that air warmed by the fins can rise inside the luminaire and transfer its heat to it. Air cooled by the luminaire is allowed to sink and may flow out of the luminaire via a gap between the heat sink and the luminaire. Fresh cooler air may be drawn in between the fins to replace out-flowing air. This process of heating and cooling of air established a natural convection flow. Natural convective air flow allows for efficient thermal communication between the heat sink and the luminaire, thereby allowing for lower LED junction temperature and longer LED lifetime.

### CROSS-REFERENCE TO RELATED APPLICATIONS

This application claims priority from U.S. provisional patent application U.S. Ser. No. 61/200,407, filed on Nov. 25, 2008, the entire contents of which are hereby expressly incorporated by reference.

### FIELD OF THE INVENTION

This invention relates generally to solid-state lighting and more specifically to removal of waste heat from electronic devices.

### BACKGROUND OF THE INVENTION

The invention is for a lighting fixture and lamp using a solid-state light sources such as a light emitting diode (LED) for generation of visible light.

Solid-state lighting (SSL) using light emitting diode (LED) is a new generation light source for general illumination. In particular, LEDs offer much higher energy efficiency over traditional incandescent light sources such as traditional light bulbs. All light sources convert electric power into radiant energy and heat in various proportions. Incandescent lamps emit primarily infrared (IR), with a small amount of visible light. Fluorescent and metal halide sources convert a higher proportion of the energy into visible light, but also emit IR, ultraviolet (UV), and heat. LEDs generate little or no IR or UV, and convert 15%-25% of the power into visible light. The remainder of the LED input power is converted to waste heat that must be conducted from the LED chip to the underlying circuit board and heat sinks, housings, or luminaire frame elements.

Excessive temperature directly affects both short-term and long-term LED performance. The short-term (reversible) effects are color shift and reduced light output while the long-term effect is reduced optical output (also known as “accelerated lumen depreciation”) and thus shortened useful life. Lumen depreciation in LEDs varies depending on package and system design. The primary cause of lumen depreciation is heat generated at the LED junction. LEDs do not emit heat as infrared radiation (IR) like other light sources, so the heat must be removed from the device by conduction or convection. If the LED system design has inadequate heat sinking or other means of removing the heat, the device temperature will rise, resulting in lower light output. Management of waste heat and an awareness of the operating environment are critical considerations to the design and application of LED luminaires for general illumination. Successful products will use superior heat sink designs to dissipate heat, and minimize LED junction temperature. Keeping the junction temperature as low as possible and within manufacturer specifications is necessary to maximize the performance of LEDs.

Lighting accounts for 15-20% of household electricity use in the U.S. Much of the light fixtures in U.S. homes are downlights installed in recessed light fixtures. In particular, the U.S. Department of Energy estimates there are at least 500 million recessed downlights installed in US homes, and more than 20 million are sold each year. LED produce highly directional light output which makes it possible to improve utilization of produced light by two-fold from traditional light sources. This feature makes LED-based SSL highly suitable in downlight applications. In particular, LED-based SSL would be an improvement over the most common lamp type used in residential downlights, the 65-watt reflector incandescent flood bulb (also known as “R-30”). Given the prevalence of downlights in US homes, potential energy savings from high-performing, energy-efficient LED-based solid-state downlights would be very significant.

Preferably, LED downlight would be configured as a direct (screw-in) replacement for R-30 incandescent lamp bulb and use existing recessed light luminaire without any modification. The challenge in cooling LED down light is the transport of waste heat from the LED to ambient air and/or the luminaire. A recent attempt at an LED-based R-30 compatible SSL lamp suitable for downlight applications known as enLux R-30 series LED available from enLux in Tempe, Ariz. is shown in FIGS. 1A and 1B. This device transports waste heat from LED to an air-cooled finned heat sink. When the enLux SSL flood lamp is installed in a recessed light luminaire pointed downward, air heated by the heat sink is trapped inside the upper part of the luminaire, thus inhibiting efficient natural convection for transferring heat from the heat sink fins to the luminaire. As a result, this product operates at a substantially elevated LED junction temperatures, which significantly limits LED lifetime.

In summary, prior art does not teach a SSL fixture and/or lamp suitable for downlight application having very efficient cooling. It is against this background that the significant improvements and advancements of the present invention have taken place.

### SUMMARY OF THE INVENTION

The present invention provides an LED-based SSL fixture and lamp for down light for use in applications especially in recessed lighting. In particular, the lamp of the subject invention may be configured as a direct screw-in replacement for common R-30 style incandescent flood lamp and it may be used existing luminaires.

In one preferred embodiment of the present invention, a lamp mounted in a recessed light luminaire for down lighting has one or more LEDs that are thermally coupled to a heat sink having fins for cooling by ambient air. The fins are configured so that air warmed by the fins can rise inside the luminaire and transfer its heat to it. Air cooled by the luminaire is allowed to sink and may flow out of the luminaire via a gap between the heat sink and the luminaire. Fresh cooler air may be drawn in between the fins to replace out-flowing air. This process of heating and cooling of air established a natural convection flow. Natural convective air flow allows for efficient thermal communication between the heat sink and the luminaire, thereby allowing for lower LED junction temperature and longer LED lifetime.

Accordingly, it is an object of the present invention to provide an LED-based SSL lamp for screw-in replacement of incandescent flood lamp in recessed light applications.

It is another object of the invention to provide improved means for cooling LED used in SSL downlights.

It is still another object of the invention to prolong the life of LED used in SSL downlight.

It is yet another object of the invention to provide a SSL flood lamp for use with existing recessed light luminaires in downlight applications.

These and other objects of the present invention will become apparent upon a reading of the following specification and claims.

### BRIEF DESCRIPTION OF THE DRAWINGS

FIG. 1A shows a side view of an SSL flood lamp of prior art.

FIG. 1B shows an end view of an SSL flood lamp of prior art.

FIG. 2 shows an isometric view of an SSL fixture in accordance with one embodiment of the subject invention.

FIG. 3 is an isometric view an LED-based SSL lamp shown in FIG. 2.

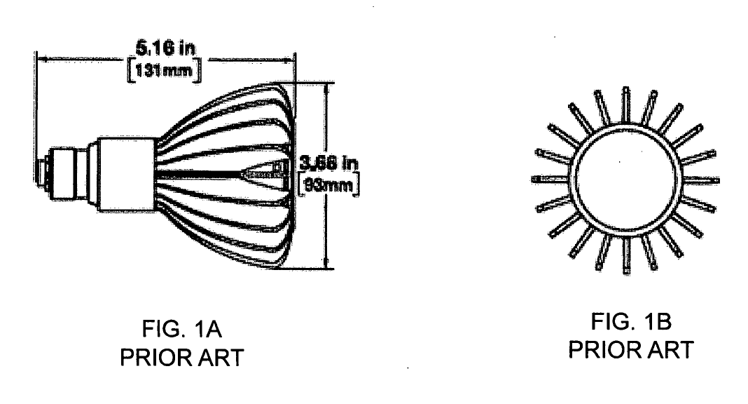

### DETAILED DESCRIPTION OF THE PREFERRED EMBODIMENTS

Selected embodiments of the present invention will now be explained with reference to drawings. In the drawings, identical components are provided with identical reference symbols. It will be apparent to those skilled in the art from this disclosure that the following descriptions of the embodiments of the present invention are merely exemplary in nature and are in no way intended to limit the invention, its application, or uses.

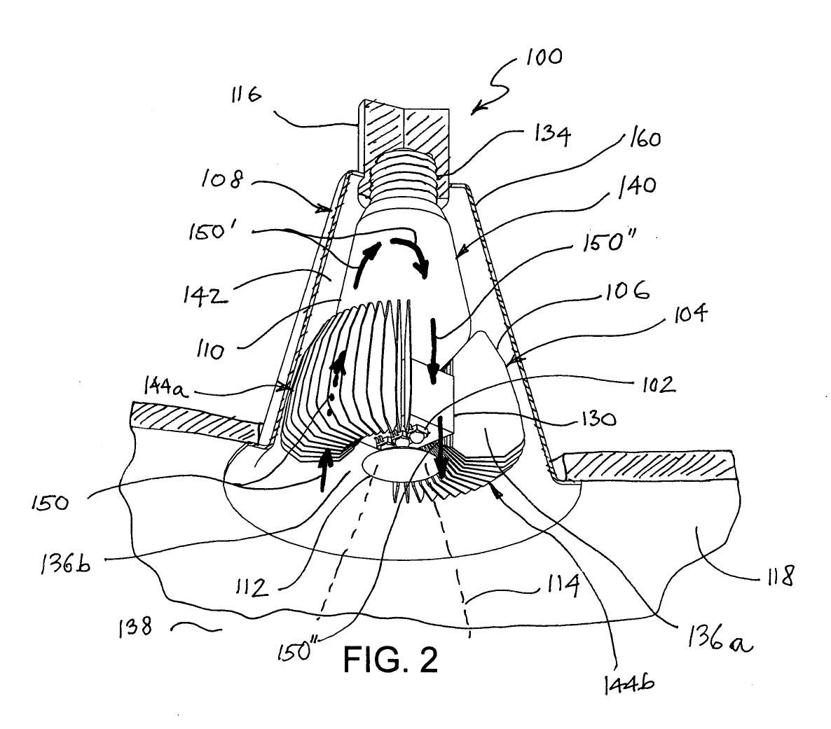

Referring now to FIG. 2, there is shown an isometric view of SSL fixture 100 in accordance with one preferred embodiment of the subject invention. The SSL fixture 100 comprises a luminaire 108, and an SSL lamp 140. The luminaire 108 may be a conventional recessed light luminaire and it may be installed in a ceiling panel 118. Typically, a recessed light luminaire is adapted for dissipation of waste heat received from a lamp bulb to the space above the ceiling panel 118. The luminaire 108 may further comprise a socket 116 and a luminaire shell 160. The socket 116 may comprise a conventional Edison style thread. The socket 116 may be formed to provide each an electrical connection to utility grid and a mechanical suspension for the SSL lamp 140. The SSL lamp 140 further comprise a heat sink 104 and one or more LED 102 such as Luxeon K2 made by Philips Lumileds Lighting Company in San Jose, Calif. The LED 102 is appropriately mounted to establish a good thermal contact with the heat sink 104. The heat sink 104 may further comprise a body 130 and air-cooled fins 106. The body 130 and air-cooled fins 106 are arranged to be in a good thermal communication. The heat sink 104 is preferably made of materials having high thermal conductivity such as, but not limited to aluminum, copper, and zinc. The body 130 may comprise a passive or active heat spreading component. For example, the body may be configured as an active heat transfer component such as disclosed by the Applicant in his co-pending U.S. patent application Ser. No. 12/290,195, entitled “Heat Transfer Device,” filed on Oct. 28, 2008.

The SSL lamp 140 may further include a base 134 for installation into the socket 116, and a power supply/controls 110 adapted for converting alternating current provided to socket 116 (typically at 120 volts or 240 volts) to direct current at a suitable lower voltage for operation of the LED 102. The base may comprise Edison style thread as appropriate for mating with the socket 116. The power supply/controls 110 may also include a structural connection between the threaded base 134 and the heat sink 104. A light shaping element 112 may be provided to shape and/or redirect at least a portion of LED output light 114.

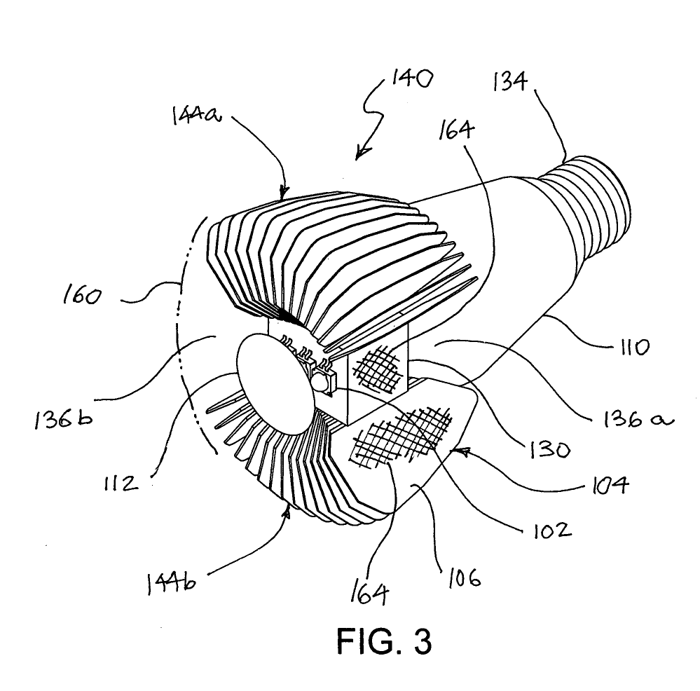

Referring now to FIG. 3, there is shown an isometric view of the SSL lamp 140. The fins 106 are preferably extending in a generally radial direction, however, the azimuthal coverage of the fins is limited. In particular, the fins are configured in two groups 144a and 144b having passages 136a and 136b therebetween. Preferably, the passages have a hydraulic diameter at least 1 centimeter and most preferably at least 1.5 centimeter.

In operation, electric power flows from the socket 116 to the power supply/controls 110 and therefrom to the LED 102, causing the LED to generate light output 114 (FIG. 3). A portion of the electric energy supplied to the LED is converted into waste heat that is transferred to the body 130 and therefrom to the fins 106. Ambient air 138 is drawn from the space below the ceiling panel 118 into the space between the fins 106 and heated (FIGS. 2 and 3). Warm air is buoyant and rises forming an air stream 150. Air stream 150 enters the space 142 between the SSL lamp 140 and the luminaire 108, contacts the luminaire shell 160, and transfers some of its heat to it, thereby producing a cooler air stream 150′. Cooler air is less buoyant and sinks downward forming a stream 150″ flowing through the passages 136a and 136b. To reduce thermal communication between the heat sink 104 and the air stream 150″, selected surfaces facing the passages 136a and 136b may be provided with thermal insulation 164 (FIG. 2). Cooler air stream 150″ may substantially flow out of the luminaire or it may be, at least in-part, drawn back in between the fins 106. In either case, a natural convective air flow is established allowing for efficient transfer of LED waste heat from fins 106 to the luminaire 108. Heat received by the luminaire is dissipated to the space above the ceiling panel 118.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments.

What is claimed is:

1. An electric lighting fixture comprising:
a) a lamp comprising a light emitting diode (LED), a base, a heat sink, and a power supply; and
b) a luminaire comprising a luminaire shell and a socket;
said socket electrically connected to a source of electric power;
said lamp base being installed in said luminaire socket and electrically connected thereto;
said LED being electrically connected to said base via said power supply;
said heat sink mechanically attached to said base;
said LED being in a good thermal contact with said heat sink; and
said heat sink formed to provide a passage between said lamp and said luminaire shell.

2. The electric lighting fixture of claim 1, wherein said heat sink further comprises a plurality of fins extending to the proximity of said luminaire shell.

3. The electric lighting fixture of claim 1, wherein said passage has a hydraulic diameter at least 1 centimeter.

4. The electric lighting fixture of claim 1, wherein said luminaire is adapted for installation in a ceiling.

5. The electric lighting fixture of claim 1, wherein said lighting fixture is adapted for down lighting.

6. An electric light fixture comprising:
a) a luminaire comprising a luminaire shell and a socket, said luminaire being adapted for recessed lighting and is installed in a ceiling;
b) a lamp comprising a light emitting diode (LED), a base, a heat sink, and a power supply; said lamp being installed in said luminaire; said heat sink adapted for flowing air therethrough; and
c) a passage between said heat sink and said luminaire shell suitable for flowing air from the proximity of said lamp base to the space below said ceiling.

7. The electric lighting fixture of claim 6, wherein:
a) said LED being electrically connected to said base via said power supply;
b) said heat sink mechanically attached to said base; and
c) said LED being in a good thermal contact with said heat sink.

8. The electric lighting fixture of claim 6, wherein said passage being substantially thermally insulated from said heat sink.

9. The electric lighting fixture of claim 6, wherein said heat sink is formed to flow air from the space below said ceiling to the proximity of said base.

10. The electric lighting fixture of claim 6, wherein said base is threaded.

11. The electric lighting fixture of claim 6, wherein said is connected to a supply of electric power.

12. A method for cooling electric light fixture comprising the steps of:
a) presenting a luminaire comprising a luminaire shell and a socket, said luminaire being adapted for recessed lighting and is installed in a ceiling;
b) presenting a lamp comprising a light emitting diode (LED), a base, a heat sink, and a power supply; said lamp being installed in said luminaire; said heat sink adapted for flowing air therethrough;
c) presenting a passage between said heat sink and said luminaire shell suitable for flowing air from the proximity of said lamp base to the space below said ceiling;
d) operating said LED to generate light and waste heat;
e) transferring said waste heat to said heat sink;
f) drawing ambient air from below said ceiling into said heat sink;
g) heating said air in said heat sink to produce a warm air stream;
h) transferring heat from said warm air stream to said luminaire to produce a cooled air stream;
i) flowing said cooler air stream into the space below said ceiling.
